(19) United States
(12) Patent Application Publication
(10) Pub. No.: US 2026/0209028 A1
(43) Pub. Date: Jul. 23, 2026

(54) SADDLE TREES

(71) Applicants: David KEMPSELL, Canterbury, Kent (GB); Margaret Lesley WHITE, Canterbury, Kent (GB)

(72) Inventors: David KEMPSELL, Canterbury, Kent (GB); Margaret Lesley WHITE, Canterbury, Kent (GB)

(21) Appl. No.: 19/141,316

(22) PCT Filed: Dec. 20, 2023
(86) PCT No.: PCT/EP2023/087044

§ 371 Date: Jun. 20, 2025

(30) Foreign Application Priority Data
Dec. 20, 2022 (GB) 2219261.1

(51) Int. Cl. B68C 1/02; B68C 1/16

(52) U.S. Cl. CPC B68C 1/025; B68C 1/16

(57) ABSTRACT

Saddle trees are described, particularly saddle trees for saddles for horse riding. We describe a saddle tree having a pommel section which includes a pommel plate having an upper surface and a lower surface and formed of a flexible sheet material and comprises a left pair of reinforcement plates and a right pair of plates. Each pair of reinforcement plates includes an upper plate and a lower plate and is mounted to the pommel plate with the pommel plate between the two reinforcement plates of each pair. The pommel section further includes a headplate and a headplate support member mounted to an underside of the pommel plate. The saddle tree further includes an arcuate collar mounted to an upper surface of the pommel plate to urge the pommel plate to adopt a curvature corresponding to a curvature of the seat section.

The present invention relates to saddle trees, particularly saddle trees for saddles for horse riding. More particularly, the present invention relates to improvements in the front region of saddle tree known as the “pommel” and how this section of the tree can move sympathetically with a horse's muscular skeletal system with the least resistance whilst at the same time distributing a rider's weight evenly over the horse's back.

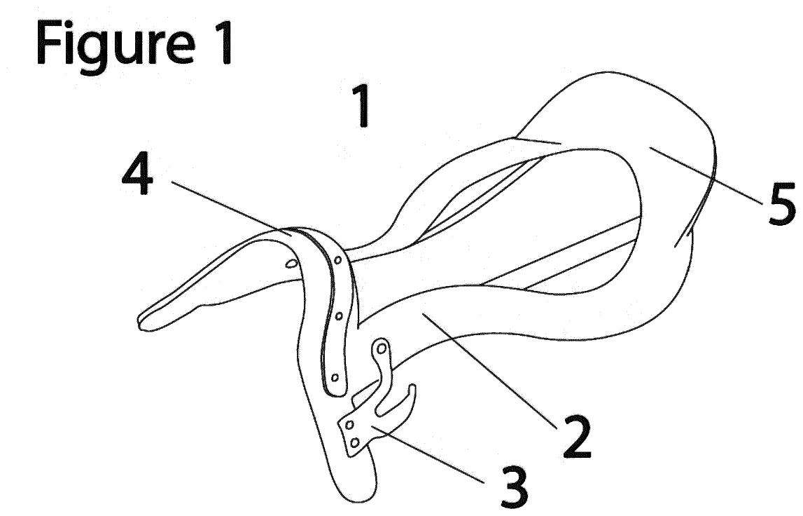

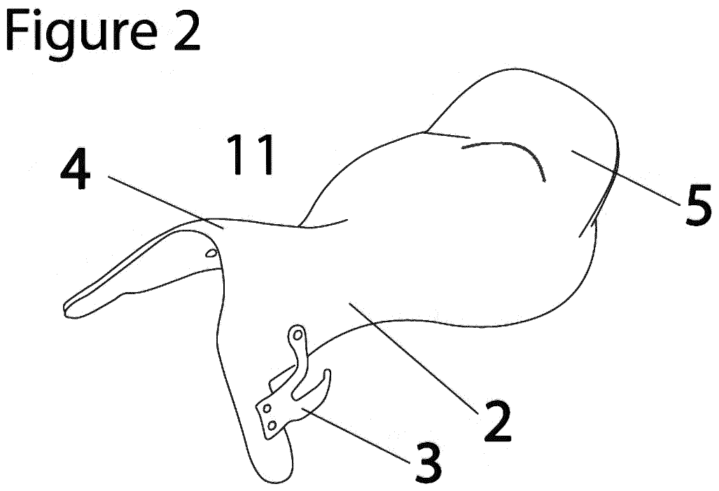

There are numerous saddle tree constructions. The two most common are:
i) A framed tree with a tear drop-shaped open frame 1 as shown in FIG. 1, in which bars 2 of the saddle tree are formed on or in a mould, the former using laminated ply wood, carbon fibre or glass fibre, the later using various blends of plastic.
ii) A solid tree 10, as illustrated in FIG. 2, which has no opening under the rider. The tree is typically formed by moulding, using either resins or plastics.

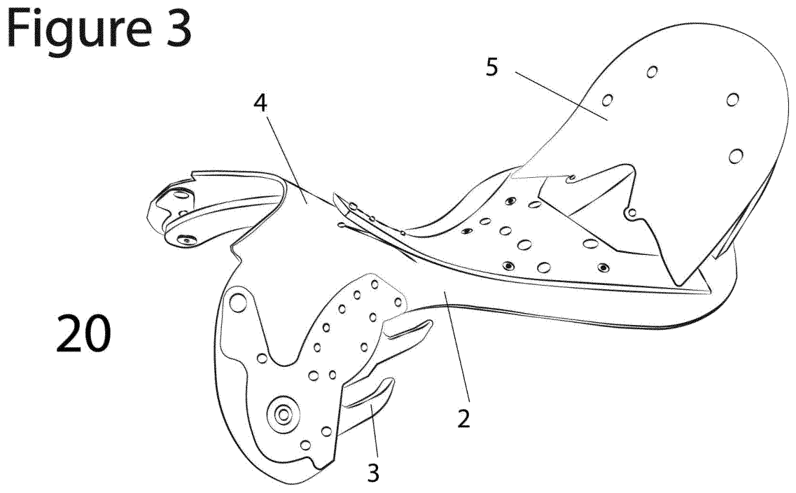

In our earlier patent application, number WO 03/089367, we described a tree, now sold as our WOW saddle tree, shown as reference 20 in FIG. 3, which has a Y-shaped rigid frame with peripheral tree components formed using a flexible polypropylene. In WO 2007/129117, we described a saddle tree using a Y-shaped rigid frame and leather components.

With reference to FIGS. 1, 2 & 3, the flexibility of the tree is dependent on the materials used and their properties. These trees may or may not have a degree or degrees of flexion and by the addition of more rigid materials in preferred areas of the tree 1, 10 or 20, the direction of flexion maybe limited in certain preferred areas. This is most true for the embodiment of FIG. 3, where our own patents (WO 03/089367 and WO 2007/129117, both of which are incorporated herein by reference for all purposes) have explained how to create a tree with what we consider to be the best direction of flexion, namely laterally and only in the front section of the saddle or pommel 4, whilst providing total longitudinal rigidity.

The tree 1, 10, 20 has tree bars 2, each with a respective stirrup bar 3, for attachment of stirrups to the saddle. These stirrup bars 3 have to be safely and securely attached to the tree bar 2 as they have to endure the forces exerted by the rider when riding and especially when landing from a jump. This requires that the tree be very resilient.

As explained in our previous patent applications, the back of a horse in locomotion changes shape most significantly at the region of the shoulders of the horse, that area directly in front of where the saddle sits on the horse. This is due to the scapulae of the horse rotating backward and under the saddle as the horse protracts its legs in motion.

This presents a problem. With the bars requiring to be resilient, lateral flexibility in the pommel 4 of the saddle is limited by the amount of distortion the bars 2 will allow. Also, the more the bars 2 distort, the amount of pressure required to achieve even more lateral rotation increases exponentially. There is therefore a limiting factor on what the horse can comfortably achieve under saddle as their movement gets bigger.

There are numerous designs of saddle that proport to being flexible, one such being GB2330513A, but we do not consider that a saddle which has a main purpose of distributing a rider's weight over the horse's back can do this if the flexibility of the tree is longitudinal. We therefore only concern ourselves with the front of the saddle being laterally flexible whilst the rest of the saddle remains rigid and supporting of the rider's weight. Moreover, the saddle should be longitudinally rigid from pommel 4 to cantle 5.

The present invention aims to overcome these problems.

We have therefore sought to produce a saddle that will be rigid as described above but with pommel area that is laterally flexible, and that flexibility will not be limited by the material distortion but only by physical limitations we choose to impose. We also seek to ensure that the pommel 4 area of the saddle will be of sufficient strength to support the stirrup bars 3 and endure the forces exerted by riding a horse, and to do so across all disciplines of the sport.

More specifically, the present invention provides a saddle tree having a cantle end and a pommel end and comprising a pommel section, a seat section and an axially aligned Y-shaped strengthening bar having forks directed towards the cantle end of the saddle tree and an elongate portion directed to the pommel end of the tree and aligned with an axis of the saddle tree.

The pommel section includes a pommel plate having an upper surface and a lower surface and formed of a flexible sheet material and comprises a first, or left, pair of reinforcement plates and a second, or right pair, of reinforcement plates, wherein each pair of reinforcement plates includes an upper plate and a lower plate and wherein each pair of reinforcement plates is mounted to the pommel plate with the pommel plate between the two reinforcement plates of each pair.

The pommel section preferably further includes a headplate and a headplate support member mounted to an underside of the pommel plate.

The pommel plate is mounted to the elongate portion of the strengthening bar.

The seat section includes a seat plate mounted to the forks of the strengthening bar, a cantle and a cantle support, each mounted to the strengthening bar;

Optionally, the seat plate is formed as a pair of seat plates, each plate of said pair being mounted to a respective fork of the strengthening bar.

The seat section and pommel section are mounted to the strengthening bar to provide a space or gap therebetween.

Preferably, the saddle tree further includes an arcuate collar mounted to an upper surface of the pommel plate to urge the pommel plate to adopt a curvature corresponding to a curvature of the seat section.

In certain embodiments, the seat plate and/or pommel plate are formed of a polymeric sheet material, optionally polypropylene.

Optionally, the polymeric sheet material has a thickness of from 1.5 mm to 4 mm, optionally about 3 mm.

In preferred embodiments, the strengthening bar is formed of a carbon fibre-reinforced polymeric material, optionally having a thickness of from 2 to 7.5 mm, 3 to 6 mm, or about 5 mm.

In preferred embodiments, the pommel section is secured to the strengthening bar only along a centre line of the tree.

In certain embodiments, the headplate support is fixed along a centre line of the tree to the pommel plate and the strengthening bar, optionally the headplate support is fixed only along the centre line of the tree.

In a further aspect, the present invention also provides a saddle comprising a saddle tree as define above.

Optionally, the saddle further comprises a pair of stirrup bars, each stirrup bar being mounted to a respective left or right portion of the pommel plate between a respective pair of reinforcement plates.

The above and other aspects of the present invention will now be described in further detail, by way of example only, with reference to the accompanying figures, in which:

FIG. 1 illustrates a traditional prior art saddle tree for seat construction with an open frame;

FIG. 2 illustrates a traditional prior art solid or closed saddle tree;

FIG. 3 illustrates a saddle tree of our earlier disclosure (WO 03/089367);

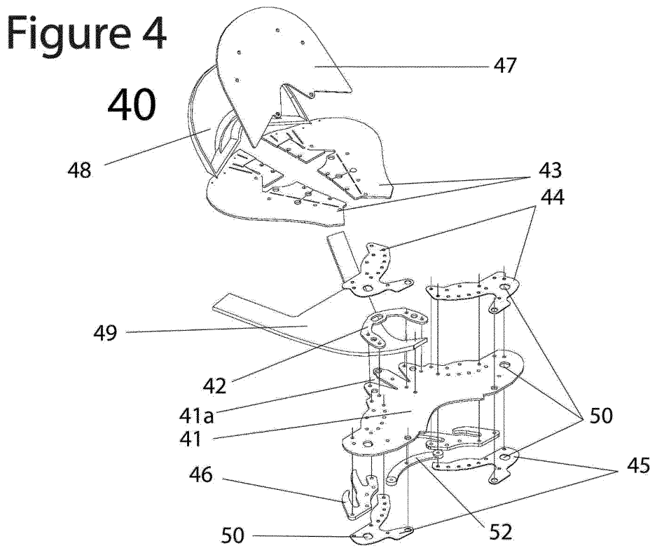

FIG. 4 is an exploded perspective view of an embodiment of the saddle tree of the present invention;

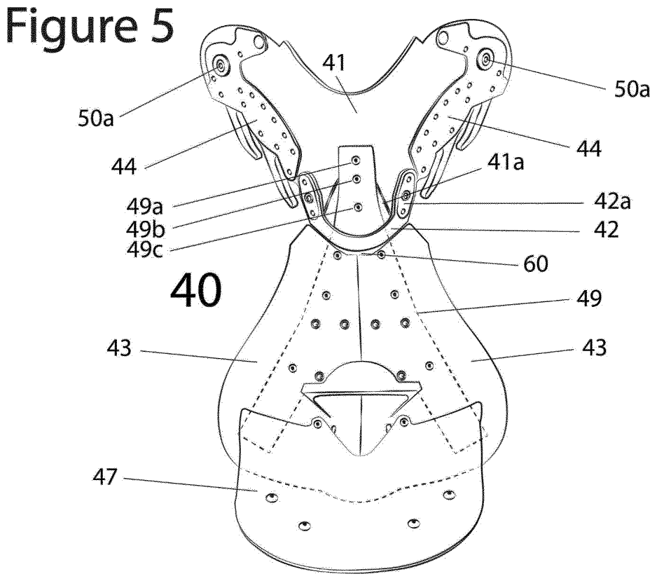

FIG. 5 is a top view of the assembled embodiment of the saddle tree of FIG. 4;

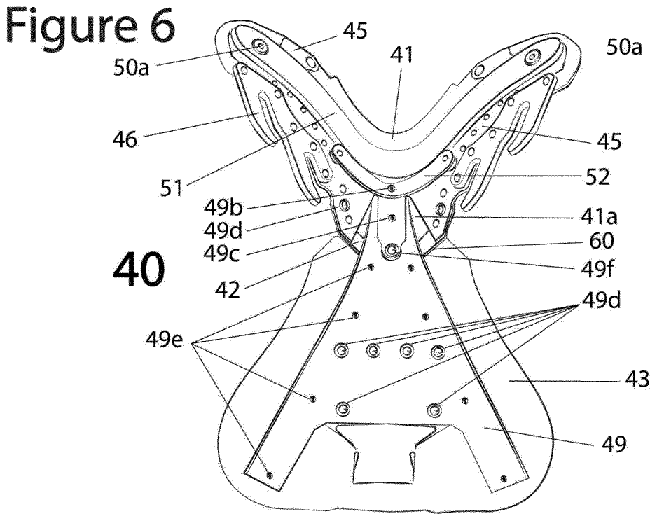

FIG. 6 is a bottom view of the embodiment of FIGS. 4 and 5;

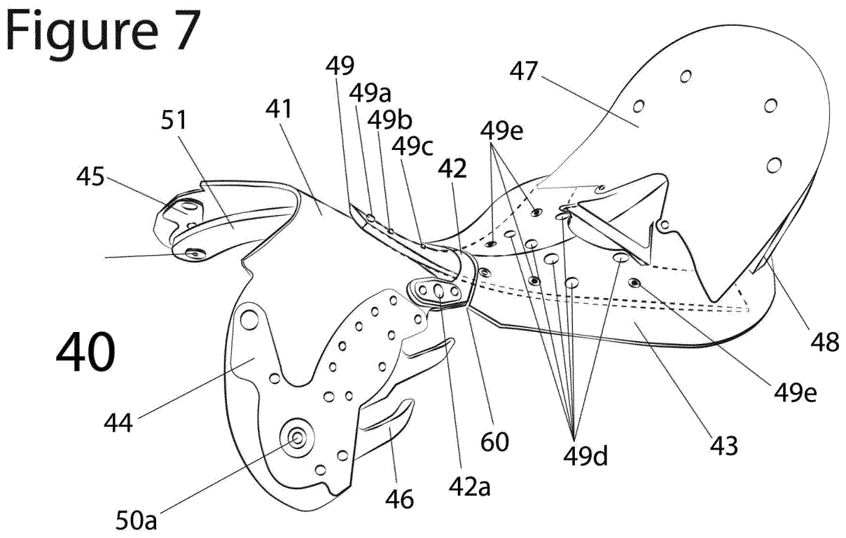

FIG. 7 is a side isometric view of the embodiment of FIGS. 4 to 6; and

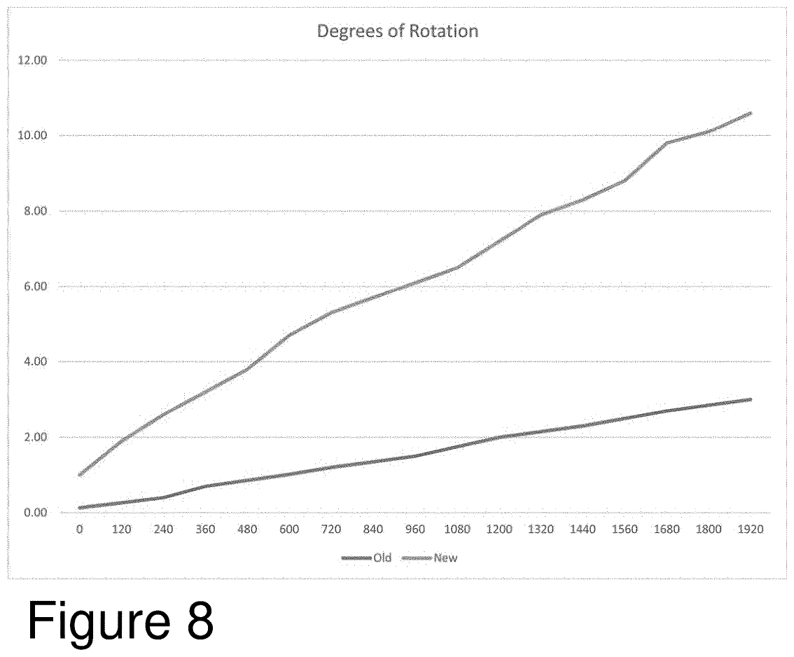

FIG. 8 is a graph plotting rotation against pressure for the saddle tree of FIGS. 4 to 7 compared with a saddle tree of WO 03/089367.

Accordingly, with reference to the accompanying FIGS. 4, 5, 6 & 7, a preferred embodiment of a saddle tree 40 is shown, having a front pommel section having a pommel section plate 41 and a seat section having a seat section plate 43. In the embodiment shown, seat section plate 43 comprises two seat section plate portions. The pommel and seat section plates are preferably made of 3 mm polypropylene sheet, or any other material having similar properties of resilience and flexibility. The pommel and seat sections of the tree are not connected by any material other than the foam and leather that will form the saddle's finished seat cushioning and cover that goes over the top of the finished tree.

The pommel section plate 41 carries a spaced pair of stainless steel reinforcement plates 44, on the upper surface, and 45, on the lower surface, which are riveted together through the available holes formed in 41, 44 & 45 to form a pair of plates with the pommel section plate 41 secured therebetween. This ensures that the pommel section has sufficient strength and stiffness that stirrup bars 46 have a safe and secure fixing via the compatible five holes in 41, 44 & 46.

The reinforcement plates 44 & 45 also provide strength for a respective machined fixing 50a which fits through holes 50 in each of 41, 44 & 45. These machined fixings 50a secure the headplate 51. Headplate 51 is suitably a shaped and bent structure formed from 6 mm steel bar and which can be formed at a selection various angles to match the angle of the horse's withers which sit directly underneath the headplate 51.

A headplate support 52, as shown, having a generally banana or arcuate form, provides a third point of fixing for the headplate 51 by the means of stopping the headplate 51 from rotating backwards. The headplate support 52 is fixed in the centre line of the tree by a pop rivet 49b and is preferably only fixed at this point. Rivet 49b holds the headplate support 52 to the pommel section 41 and a carbon fibre Y Bar 49, as is described in detail in our earlier applications, to which further reference should be made. In the embodiment shown, this is one of four fixing points that hold the pommel section 41 on the centre line of the tree to the carbon fibre Y Bar 49, these being identified in FIG. 5 as 49a, 49b, 49c & 49f. Fixing point 49f is conveniently a M10 screw-in fitting with an internal M6 thread to provide means of mounting saddle parts to the saddle tree.

In preferred embodiments, carbon fibre Y Bar 49 is about 5 mm thick, providing a very strong and rigid longitudinal strength to the tree 40.

Further fittings 49d, suitably M10 fittings, mount other parts of the completed saddle. These all secure directly into the carbon fibre Y Bar 49, providing a strong, resilient and reliable form of attachment of saddles component parts i.e., flaps and panels and girthing.

The seat section of the saddle tree 40 is formed, in the illustrated embodiment, from seat section plates 43, cantle 48 and cantle support 47. These three components are secured to the carbon fibre Y Bar 49 with blind or pop rivets 49e and provide a rigid flat surface onto which the foam of the finished seat can be formed. The seat section plate or plates 43 is conveniently made from 3 mm polypropylene, which is a material which allows the seat leather to be secured in place using staples. With the pommel section 41, collar 42 and seat section 43 mounted on the Y Bar 49, there is a spacing or gap 60 between the two sections, of approximately 3 mm. Pommel section 41 is mounted under the Y Bar 49 and the seat section 43 is mounted above the Y Bar 49. Therefore, these two sections will not meet on the same plane at gap 60, a feature which is exacerbated in saddle trees in which headplate 51 has a narrow angle, such as 73°, as is currently used on horses that are very high and skinny in the withers.

With reference to FIGS. 4 to 7, in the preferred embodiments, the pommel section is only fixed down the centre line of the tree with fixings 49a, 49b, 49c and 49f. This allows the whole pommel section to swing laterally without restriction, which is not preferable. The force required to move the pommel section laterally will be reduced compared with the previous methods of making the saddle tree 1, 10, and 20, as shown in FIGS. 1 to 3, because the split between the two sections 60 ensure that effect the traditional bars 2 have on the motion of the pommel 4 are negated.

Therefore, to limit the movement whilst ensuring the pommel section 41 and seat section 43 meet on the same plane at gap 60, a collar 42 is fixed to pommel section 41 via pop rivets and a stainless steel plate 42a on either side of the pommel section 41. Collar 42 sits on top of the Y Bar and therefore forces pommel section 41 to take the curvature and plane of the seat section.

To limit the amount of movement the pommel section 41 can have, the pommel section 41 has V-shaped grooves 41a either side of a central tongue that holds fixing points 49d and 49f. The outer edges of grooves 41a are flexed up the side of the Y Bar 49 as a result of the collar 42 pulling on the area of pommel section 41 where it connects to collar 42 at plate 42a. The width of the V-shaped groove 41a will dictate the amount of lateral twist that pommel section 41 can achieve until it hits a dead stop when the V-shaped groove 41a contacts the carbon fibre Y Bar 49 side.

Finally, the collar 42 ensures that when an upward turning force is applied to pommel section 41, for instance when landing from a jump, the pommel section 41 cannot move as the collar 42 is over the top of the tree and this will negate this turning motion. In our earlier tree designs, this was achieved by the bars 2 being integral to both pommel and seat area of the tree.

This innovative design of tree has distinct mechanical advantage over the version of the tree outlined in WO 03/089367. Measurements taken by applying a force of 1.92 kg to the pommel section laterally achieve a rotation of 3.0° in the prior art tree, whereas the same rotation was obtained with an applied force of just 240g in the described embodiment of the present invention. FIG. 8 is a plot of rotation (y-axis) against pressure (x-axis) for both trees, from which it can be seen that embodiments of the tree of the present invention have a clear and substantial advantage over the prior art saddle tree, which aids a horse's ability to move under saddle and, ultimately, improves the horse's welfare.

1. A saddle tree having a cantle end and a pommel end and comprising a pommel section, a seat section and an axially aligned Y-shaped strengthening bar having forks directed towards the cantle end of the saddle tree and an elongate portion directed to the pommel end of the tree and aligned with an axis of the saddle tree;
wherein the pommel section includes a pommel plate having an upper surface and a lower surface and formed of a flexible sheet material and comprises a first, or left, pair of reinforcement plates and a second, or right pair, of reinforcement plates, wherein each pair of reinforcement plates includes an upper plate and a lower plate and wherein each pair of reinforcement plates is mounted to the pommel plate with the pommel plate between the two reinforcement plates of each pair;
wherein the pommel section further includes a headplate and a headplate support member mounted to an underside of the pommel plate;
wherein the pommel plate is mounted to the elongate portion of the strengthening bar;
wherein the seat section includes a pair of seat plates, each plate of said pair being mounted to a respective fork of the strengthening bar, a cantle and a cantle support, each mounted to the strengthening bar;
wherein the seat section and pommel section are mounted to the strengthening bar to provide a space or gap therebetween;
wherein the saddle tree further includes an arcuate collar mounted to an upper surface of the pommel plate to urge the pommel plate to adopt a curvature corresponding to a curvature of the seat section.

2. The saddle tree as claimed in claim 1 wherein the seat plates and/or pommel plate are formed of a polymeric sheet material.

3. The saddle tree as claimed in claim 2 wherein the polymeric sheet material has a thickness of from 1.5 mm to 4 mm.

4. The saddle tree as claimed in claim 1 wherein the strengthening bar is formed of a carbon fibre-reinforced polymeric material.

5. The saddle tree as claimed in claim 1 wherein the pommel section is secured to the strengthening bar only along a centre line of the tree.

6. The saddle tree as claimed in claim 1 wherein the headplate support is fixed along a centre line of the tree to the pommel plate and the strengthening bar.

7. The saddle tree as claimed in claim 6 wherein the headplate support is fixed only along the centre line of the tree.

8. A saddle comprising a saddle tree as claimed in claim 1.

9. The saddle as claimed in claim 8 further comprising a pair of stirrup bars, each stirrup bar being mounted to a respective left or right portion of the pommel plate between a respective pair of reinforcement plates.

10. The saddle tree as claimed in claim 2, wherein the polymeric sheet material is polypropylene.

11. The saddle tree as claimed in claim 3, wherein the polymeric sheet material has a thickness of about 3 mm.

12. The saddle tree as claimed in claim 4, wherein the strengthening bar has a thickness of from 2 to 7.5 mm, 3 to 6 mm, or about 5 mm.
